(19) United States
(12) Patent Application Publication
(10) Pub. No.: US 2022/0328934 A1
(43) Pub. Date: Oct. 13, 2022

(54) ELECTROLYTIC SOLUTION ABSORBING PARTICLES, SELF-SUPPORTING SHEET, LITHIUM-ION SECONDARY BATTERY ELECTRODE, SEPARATOR, AND LITHIUM-ION SECONDARY BATTERY

(71) Applicant: HONDA MOTOR CO., LTD., Tokyo (JP)

(72) Inventors: Kazuki SAIMEN, Saitama (JP); Takashi NAKAGAWA, Saitama (JP); Takeshi FUJINO, Saitama (JP)

(21) Appl. No.: 17/616,183

(22) PCT Filed: Jun. 4, 2019
(86) PCT No.: PCT/JP2019/022160

§ 371 Date: Dec. 2, 2021

(51) Int. Cl. H01M 50/48; H01M 10/0525; H01M 4/04; H01M 50/46

(52) U.S. Cl. CPC H01M 50/48; H01M 10/0525; H01M 4/0404; H01M 50/46

(57) ABSTRACT

Provided are electrolytic solution absorbing particles that have an electrolytic solution retention property and can increase a lithium ion transport characteristic, as well as a self-supporting sheet that includes the same, a lithium-ion secondary battery electrode that includes the same, a separator that uses the same, and a lithium-ion secondary battery that uses the same. These particles are particles wherein a resin layer that can absorb an electrolytic solution is provided on a surface of a highly dielectric oxide solid. Specifically, these particles are electrolytic solution absorbing particles that have the resin layer that can absorb the electrolytic solution on the surface of the highly dielectric oxide solid.

### TECHNICAL FIELD

The present invention relates to electrolytic solution-absorbing particles, a self-supporting sheet including electrolytic solution-absorbing particles, an electrode that is for use in lithium-ion secondary batteries and includes electrolytic solution-absorbing particles, a separator including electrolytic solution-absorbing particles, and a lithium-ion secondary battery including electrolytic solution-absorbing particles.

### BACKGROUND ART

In the conventional art, lithium-ion secondary batteries are in widespread use as high-energy-density secondary batteries. A lithium-ion secondary battery containing a liquid electrolyte has a structure including positive and negative electrodes, a separator in between them, and the liquid electrolyte (electrolytic solution) filled in the separator.

In general, lithium-ion secondary batteries contain a flammable organic solvent in the electrolytic solution and may especially have a heat safety problem. Therefore solid-state batteries are proposed, which contain a non-flammable solid electrolyte as an alternative to a liquid electrolyte containing an organic material.

Different applications have different requirements for the lithium-ion secondary batteries mentioned above. For example, batteries for automotive applications are desired not only to have a high energy density but also to be less vulnerable to degradation of output characteristics after charge and discharge cycles.

Unfortunately, in general, lithium-ion secondary batteries tend to decrease in output characteristics as they undergo repeated charge and discharge cycles. This is because the electrolytic solution undergoes decomposition during charge and discharge cycles so that a passive film forms on the electrode to gradually increase the internal resistance and that a reduction in the amount of the electrolytic solution occurs to cause shortage of the electrolytic solution.

To address that, a method for maintaining the characteristics is proposed which uses a solid electrolyte in the electrode to accelerate the dissociation of the original electrolyte and to effectively trap a free solvent (see Patent Document 1). Such a solid electrolyte can increase the diffusion of lithium as it can easily cause polarization of electrons and ions and can function to trap counter anions and a free solvent, which act as lithium diffusion inhibitors in the electrolytic solution.
Patent Document 1: Japanese Unexamined Patent Application, Publication No. 2016-167457

### DISCLOSURE OF THE INVENTION

### Problems to be Solved by the Invention

Unfortunately, particles of such a solid electrolyte cannot function to immobilize an electrolytic solution although they are highly wettable with an electrolytic solution. Therefore, the electrolytic solution can easily escape from the surface of the solid electrolyte particles due to the gravity acting on the electrolytic solution and electrode expansion and contraction associated with the charge and discharge of the lithium-ion secondary battery, so that the effect of the addition of the solid electrolyte is limited.

The present invention has been made in view of the above, and an object of the present invention is to provide electrolytic solution-absorbing particles having the ability to retain an electrolytic solution and being capable of improving lithium-ion transport performance and to provide a self-supporting sheet including such particles an electrode that is for use in lithium-ion secondary batteries and includes such particles a separator including such particles, and a lithium-ion secondary battery including such particles.

### Means for Solving the Problems

The present inventors have conducted intensive studies to solve the problems mentioned above. As a result, the present inventors have completed the present invention based on the conclusion that high-dielectric oxide solid particles with their surfaces covered with a resin layer capable of absorbing an electrolytic solution can have the ability to retain an electrolytic solution and improve lithium-ion transport performance.

The present invention is directed to electrolytic solution-absorbing particles each including: a high-dielectric oxide solid; and a resin layer that is provided on the surface of the high-dielectric oxide solid and is capable of absorbing an electrolytic solution.

In the electrolytic solution-absorbing particles the high-dielectric oxide solid may be an oxide having lithium ion conductivity.

In the electrolytic solution-absorbing particles, the high-dielectric oxide solid may be a ferroelectric oxide having a relative permittivity of 10 or more when in the form of a powder.

In the electrolytic solution-absorbing particles, the high-dielectric oxide solid may have a lithium-ionic conductivity of 10⁻⁷ S/cm or more at 25° C.

In the electrolytic solution-absorbing particles, the high-dielectric oxide solid may be a complex metal oxide having a garnet structure represented by the formula: Li_{7-y}La_{3-z}AₓZr_{2-y}M_{y}O₁₂, wherein A is any one metal selected from the group consisting of Y, Nd, Sm, and Gd, x is in the range of 0 to less than 3 (0≤x<3>, M is Nb or Ta, and y is in the range of 0 to less than 2 (0≤y<2).

In the electrolytic solution-absorbing particles, the high-dielectric oxide solid may be a complex metal oxide including crystals represented by the formula: Li_{1+x+y}(Al,Ga)ₓ(Ti,Ge)₂₋ₓSi_{y}P_{3-y}O₁₂, wherein 0≤x≤1 and 0≤y≤1.

In the electrolytic solution absorbing particles, the resin layer may have pores in which an electrolytic solution is to be filled and absorbed.

The pores may have a volume content of 30 vol % or more based on the volume of the resin layer.

Another aspect of the present invention is directed to a self-supporting sheet including the electrolytic solution-absorbing particles defined above.

Another aspect of the present invention is directed to an electrode for use in a lithium-ion secondary battery, the electrode including: an electrode active material; and the electrolytic solution-absorbing particles defined above.

The electrode for use in a lithium-ion secondary battery may contain 0.1 parts by mass or more and 5 parts by mass or less of the electrolytic solution-absorbing particles based on 100 parts by mass of the electrode.

In the electrode for use in a lithium-ion secondary battery, the electrode active material may be a positive electrode active material.

In the electrode for use in a lithium-ion secondary battery, the electrode active material may be a negative electrode active material.

Another aspect of the present invention is directed to an electrode for use in a lithium-ion secondary battery, the electrode including: a current collector; an electrode active material layer that is provided on at least one side of the current collector and includes an electrode active material; and an electrolytic solution-absorbing layer that is provided on the electrode active material layer and includes the electrolytic solution-absorbing particles.

In the electrode for use in a lithium-ion secondary battery, the electrolytic solution-absorbing layer may be provided to come into contact with a separator when used to form a lithium-ion secondary battery.

In the electrode for use in a lithium-ion secondary battery, the electrode active material may be a positive electrode active material.

In the electrode for use in a lithium-ion secondary battery, the electrode active material may be a negative electrode active material.

Another aspect of the present invention is directed to a separator for use in a lithium-ion secondary battery, the separator including: a base material; and an electrolytic solution-absorbing layer that is provided on at least one side of the base material and includes the electrolytic solution-absorbing particles.

Another aspect of the present invention is directed to a lithium-ion secondary battery including: a positive electrode layer including a positive electrode active material layer including a positive electrode active material; a negative electrode layer including a negative electrode active material layer including a negative electrode active material; a separator provided between the positive electrode layer and the negative electrode layer; an electrolytic solution; and an electrolytic solution-absorbing layer that is provided between the separator and the positive electrode layer and/or the negative electrode layer and includes the electrolytic solution-absorbing particles.

### Effects of the Invention

The electrolytic solution-absorbing particles of the present invention have the ability to retain an electrolytic solution, and therefore shortage of an electrolytic solution is prevented from occurring on their surfaces. This results in improvement of lithium-ion transport performance a reduction in the initial resistance of a lithium-ion secondary battery, and less increase in internal resistance after charge and discharge cycles.

For example, when at least one of positive and negative electrodes contains the electrolytic solution-absorbing particles of the present invention, the amount of heat generated from the electrode can be kept at a low level even during high-rate operation, so that stable battery performance can be achieved for a long time.

The surface resin layer of the electrolytic solution-absorbing particles of the present invention helps to reduce the amount of a binder when the particles are used together with the binder to form at least one of positive and negative electrodes. This results in less decrease in cell energy density.

When a layer including the electrolytic solution-absorbing particles of the present invention is disposed between a separator and at least one of positive and negative electrodes shortage of an electrolytic solution can be prevented, which would otherwise occur when the electrolytic solution is pushed out of the space between the electrode surface and the separator under a large reaction force caused by electrode expansion and contraction associated with charge and discharge. As a result, lithium precipitation can be prevented even during quick charge and discharge, so that toughness against short circuiting, which is a problem with the conventional art and battery durability can be improved.

The electrolytic solution-absorbing particles of the present invention can be adhesive because of their surface resin layer. Therefore, when disposed between a separator and at least one of positive and negative electrode layers, a layer including the electrolytic solution-absorbing particles of the present invention can prevent a gap from forming between the separator and the electrode as the electrode expands and contracts during charge and discharge.

### BRIEF DESCRIPTION OF THE DRAWINGS

FIG. 1 is a graph showing the discharge rates of lithium-ion secondary batteries produced in Examples and Comparative Examples;

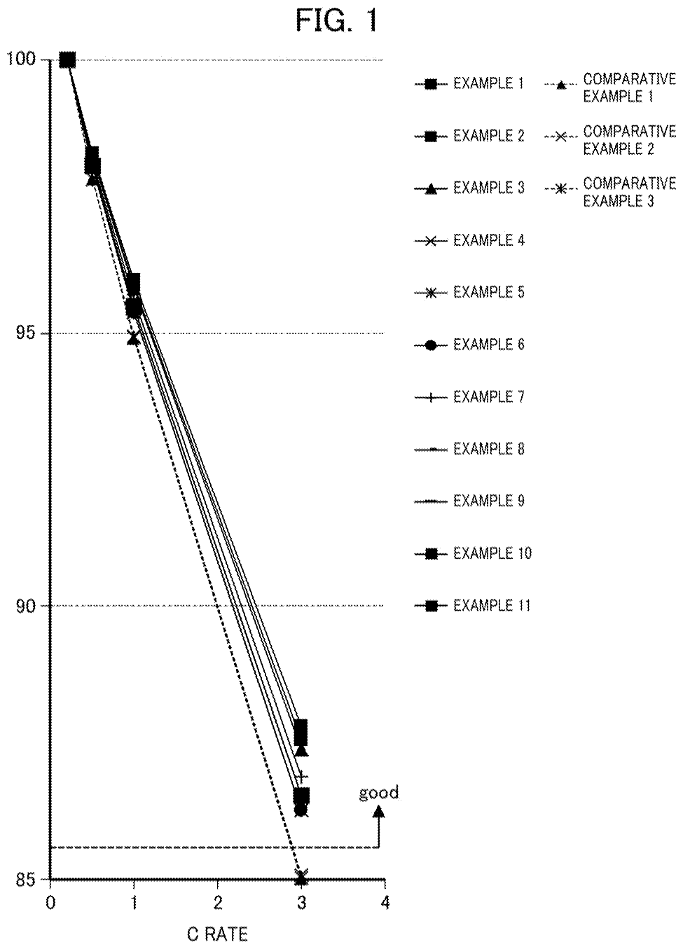

FIG. 2 is a graph showing the charge rates of lithium-ion secondary batteries produced in Examples and Comparative Examples; and

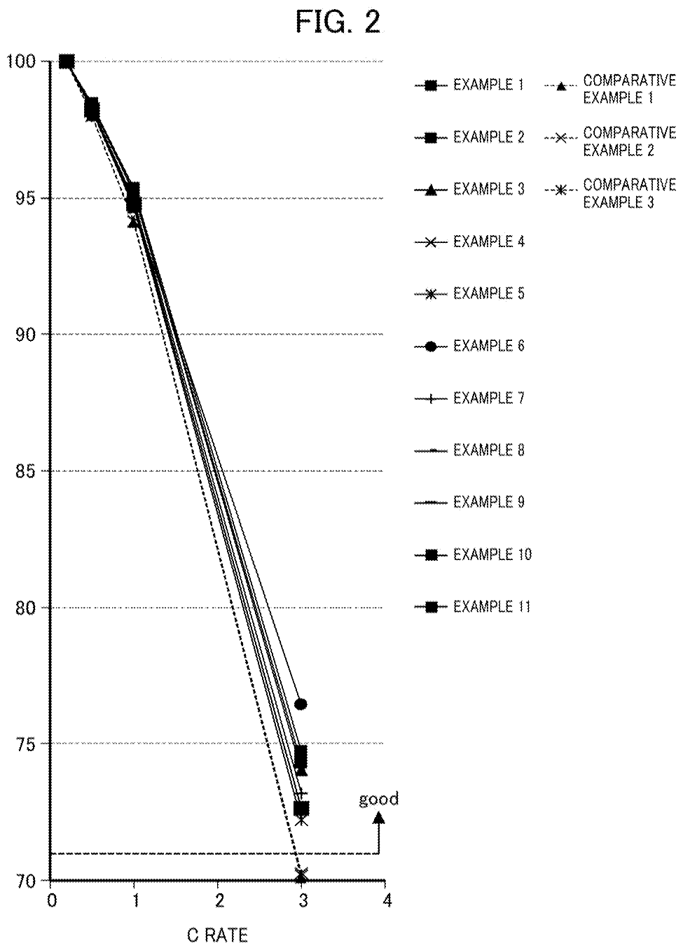

FIG. 3 is a graph showing the ceil capacities after an endurance test on lithium-ion secondary batteries produced in Examples and Comparative Examples.

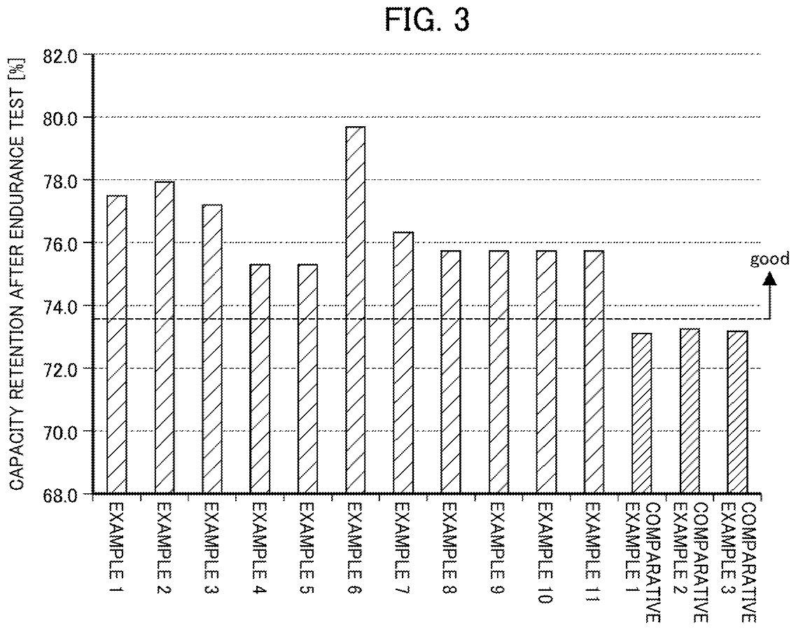

### PREFERRED MODE FOR CARRYING OUT THE INVENTION

Embodiments of the present invention will be described below. It will be understood that the embodiments described below are not intended to limit the present invention.

Electrolytic Solution-Absorbing Particles

The electrolytic solution-absorbing particles of the present invention each include a high-dielectric oxide solid and a resin layer that is provided on the surface of the high-dielectric oxide solid and is capable of absorbing an electrolytic solution.

High-Dielectric Oxide Solid

The high-dielectric oxide solid may be any solid including a high-dielectric oxide. The high-dielectric oxide solid particles may be any of various types.

Lithium Ion Conductivity

In particular, the high-dielectric oxide solid is preferably an oxide having lithium ion conductivity. When the high-dielectric oxide solid is an oxide having lithium ion conductivity, lithium ions can easily move in the electrolytic solution-absorbing particles of the present invention, which is effective in producing a dielectric effect. This makes it easy to increase the dissociation degree of the electrolytic solution.

The high-dielectric oxide solid in the electrolytic solution-absorbing particles of the present invention is preferably an oxide having an ionic conductivity of 10⁻⁷ S/cm or more at 25° C. The high-dielectric oxide solid preferably has a lithium-ionic conductivity of 10⁻⁵ S/cm or more, more preferably 10⁻⁴ S/cm or more, at 25° C.

When the high-dielectric oxide solid is an oxide having a lithium-ionic conductivity of 10⁻⁷ S/cm or more at 25° C., lithium ions can easily move in the electrolytic solution-absorbing particles of the present invention, which is effective in producing a dielectric effect,

Relative Permittivity of Powder

The high-dielectric oxide solid for forming the electrolytic solution-absorbing particles of the present invention is preferably a ferroelectric oxide having a relative permittivity of 10 or more when it is in the form of a powder. The high-dielectric oxide solid is more preferably a ferroelectric oxide having a relative permittivity of 15 or more, more preferably 20 or more, when it is in the form of a powder.

In the present invention, the relative permittivity of the high-dielectric oxide solid in the form of a powder may be determined as shown below. Method for. Measuring Relative Permittivity of Powder

The powder is placed in a 38 mm diameter (R) tablet molding machine for measurement, and compressed to a thickness (d) of 1 to 2 mm using a hydraulic press machine to give a compressed powder. The compressed powder is formed under such conditions as to achieve a powder relative density of 40% or more, which is calculated according to the formula: powder relative density (D_{powder})=(the weight density of the compressed powder/the true specific gravity of the dielectric)×100. The resulting molded product is measured for capacitance (Wo at 25° C. and 1 kHz by automatic balancing bridge method using an LCR meter, and the relative permittivity εₜₒₜₐₗ of the compressed powder is calculated from the measurement. The permittivity ε_{powder} of the solid volume part (the relative permittivity ε_{powder} of the powder) may be calculated from the resulting relative permittivity of the compressed powder using Formulas (1) to (3) below, in which ε₀ is the permittivity of vacuum (=8.854×10⁻¹²) and εₐᵢᵣ is the relative permittivity of air (=1). The contact area A between the compressed powder and the electrode=(R/2)²×π(1)

Cₜₒₜₐₗ)=εₜₒₜₐₗ×ε₀×(A/d) (2)

Eₜₒₜₐₗ=ε_{powder}×D_{powder}+εₐᵢᵣ×1−D_{powder} (3)

When used as the high-dielectric oxide solid to form the electrolytic solution-absorbing particles of the present invention, a ferroelectric oxide having a relative permittivity of 10 or more in the form of a powder can increase the dissociation degree of the electrolytic solution and reduce the resistance of the electrolytic solution.

Examples of the ferroelectric oxide having a relative permittivity of 10 or more in the form of a powder include, but are not limited to, complex metal oxides having a perovskite crystal structure, such as BaTiO₃, BaₓSr₁₋ₓTiO₃, wherein x is 0.4 to 0.8, BaZrₓTi₁₋ₓO₃, wherein x is 0.2 to 0.5, and KNbO₃, and bismuth-containing, complex metal oxides having a layered perovskite crystal structure, such as SrBi₂Ta₂O₉ and SrBi₂Nb₂O₉. At least one selected from the group consisting of these materials is preferably used in the present invention.

Examples of the oxide having a lithium-ionic conductivity of 10⁻⁷ S/cm or more at 25° C. include, but are not limited to, complex metal oxides having a garnet structure represented by the formula: Li_{7-y}La₃₋ₓAₓZr_{2-y}M_{y}O₁₂, wherein A is any one metal selected from the group consisting of Y, Nd, Sm, and Gd, x is in the range of 0 to less than 3 (0≤x<3), M is Nb or Ta, and y is in the range of 0 to less than 2 (0≤y<2).

Other examples of the oxide having a lithium-ionic conductivity of 10⁻⁷ S/cm or more at 25° C. include complex metal oxides having an NASICON crystal structure represented by the formula: Li_{1+x+y}(Al,Ga)ₓ(Ti,Ge)₂₋ₓSi_{y}P_{3-y}O₁₂, wherein 0≤x≤1 and 0≤y≤1.

More specifically, examples of the high-dielectric oxide solid constituting the electrolytic solution-absorbing particles of the present invention include Li₇La₃Zr₂O₁₂ (LLZO), Li_{6.75}La₃Zr_{1.75}Ta_{0.25}O₁₂ (LLZTO) Li_{0.33}La_{0.56}TiO₃ (LLTO), Li_{1.3}Al_{0.3}Ti_{1.7} (PO₄)₃ (LATP), t and Li_{1.6}Al_{0.6}Ge_{1.4}(PO₄)₃ (LAGP). At least one selected from the group consisting of these materials is preferably used in the present invention.

Particle Size

The electrolytic solution-absorbing particles of the present invention each include a high-dielectric oxide solid particle. The size of the high-dielectric oxide solid particle is preferably but not limited to about 0.1 μm or more and about 10 μm or less, which is not more than the active material particle size.

If the particle size is too small, the electrolytic solution-absorbing particles of the present invention contained in, for example at least one of positive and negative electrodes may adhere to the surface of the electrode active material to inhibit electron conductivity and thus to increase cell resistance. If the particle size is too large the electrolytic solution-absorbing particles of the present invention may interfere with the improvement of the active material filling rate of the electrode.

Resin Layer

The resin layer is provided on the surface of the high-dielectric oxide solid in the electrolytic solution-absorbing particles of the present invention, in the present invention, the resin layer has the function of absorbing and retaining an electrolytic solution and thus can prevent shortage of an electrolytic solution on the particle surface. This results in an increase in lithium ion transport performance, a reduction in the initial resistance of a lithium-ion secondary battery, and less increase in the internal resistance during charge and discharge cycles.

In the electrolytic solution-absorbing particles of the present invention, the resin layer preferably has pores. The electrolytic solution can be absorbed and filled in the pores. The electrolytic solution filled in the pores can be prevented from moving due to gravity and from being pushed out as the electrode expands and contracts during charge and discharge, so that shortage of the electrolytic solution can be prevented. As a result, the battery performance can be maintained at a sufficient level, and long-term stable battery performance can be obtained.

The electrolytic solution-absorbing particles of the present invention having the pore-containing resin layer may be produced by any method. For example, a process of forming a porous structure in the resin layer may be performed using a plasticizer.

When the resin layer in the electrolytic solution-absorbing particles of the invention has pores, the volume content of the pores is preferably 30 vol % or more based on the volume of the resin layer. The volume content of the pores is more preferably 50 vol % or more, even more preferably 60 vol % or more, based on the volume of the resin layer.

If the volume content of the pores is less than 30 vol % based on the volume of the resin layer, the electrolytic solution-retaining effect may fail to be produced. The resin layer with a pore volume content of 30 vol % or more can reliably retain a sufficient amount of the electrolytic solution so that the dissociation degree of the electrolytic solution can be further increased.

Self-Supporting Sheet Including Electrolytic Solution-Absorbing Particles

The self-supporting sheet of the present invention includes the electrolytic solution-absorbing particles of the present invention. The self-supporting sheet can support itself alone. The self-supporting sheet may have any size, any thickness, and any other dimensions. The self-supporting sheet may contain any additional component other than the electrolytic solution-absorbing particles of the present invention.

In the process of forming a lithium-ion secondary battery, the self-supporting sheet including the electrolytic solution-absorbing particles of the present invention is preferably disposed between a separator and a positive electrode layer and/or a negative electrode layer.

When disposed on the surface of the electrode layer, the self-supporting sheet including the electrolytic solution-absorbing particles of the present invention can increase the toughness of the ceil against internal short-circuiting. Besides the toughness against short circuiting, the self-supporting sheet including the electrolytic solution-absorbing particles of the present invention can increase durability because it has the function of retaining a sufficient amount of the electrolytic solution to prevent the electrolytic solution from being pushed out due to expansion and contraction of the electrode during charge and discharge and to prevent shortage of the electrolytic solution.

Electrode for Use in Lithium-Ion Secondary Battery First Mode (Mixture Type)

A first mode of the electrode oi the present invention for use in a lithium-ion secondary battery includes an electrode active material and the electrolytic solution-absorbing particles of the present invention.

A non-limiting example of the first mode of the electrode of the present invention for use in a lithium-ion secondary battery includes a current collector and an electrode layer that is provided on the current collector and includes an electrode material mixture including an electrode active material and the electrolytic solution-absorbing particles of the present invention. The electrode layer may contain optional known components, such as a conductive aid and a binder.

In the first mode of the electrode of the present invention used in a lithium-ion secondary battery, the electrolytic solution-absorbing particles of the present invention can keep, at a low level, the amount of heat generated during high-rate operation, so that the electrode allows the battery to provide stable performance for a long time.

Moreover, the resin layer on the surface of the electrolytic solution-absorbing particles helps to save the amount of a binder, which is used together with the particles, so that the reduction in cell energy density can be kept at a low level.

Formulation

The first mode of the electrode including an electrode active material and the electrolytic solution-absorbing particles of the present invention preferably contains 0.1 parts by mass or more and 5 parts by mass of less of the electrolytic solution-absorbing particles of the present invention based on 100 parts by mass of ail components of the electrode material mixture in the electrode. The content of the electrolytic solution-absorbing particles is more preferably in the range of 0.5 parts by mass or more and 5.0 parts by mass or less, even more preferably in the range of 0.5 parts by mass or more and 2.0 parts by mass or less.

If the content of the electrolytic solution-absorbing particles is less than 0.1 parts by mass based on 100 parts by mass of all components of the electrode material mixture in the electrode, the electrolytic solution infiltrated into the electrode may have an insufficient degree of dissociation. If the content of the electrolytic solution-absorbing particles is more than 5 parts by mass, the electrolytic solution may be infiltrated in an insufficient amount into the electrode so that, lithium ions may move through a limited route in the electrode.

The first mode of the electrode of the present invention for use in a lithium-ion secondary battery may be a positive electrode or a negative electrode. Therefore, the electrode active material in the electrode of the present invention for use in a lithium-ion secondary battery may be a positive electrode active material or a negative electrode active material. The present invention is advantageously effective for both the positive and negative electrodes.

Current Collector

The first mode of the electrode containing an electrode active material and the electrolytic solution-absorbing particles of the present invention may include any type of current collector. Any known current collector for lithium-ion secondary batteries may be used.

Examples of materials for the positive electrode current collector include metal materials, such as SUS, Ni, Cr, Au, Pt, Al, Fe, Ti, Zn, and Cu. Examples of materials for the negative electrode current collector include SUS, Ni, Cu, Ti, Al, baked carbon, electrically-conductive polymers, electrically-conductive glass, and Al—Cd alloys.

The electrode current collector may be, for example, in the form of a foil, a plate, or a mesh. The thickness of the electrode current collector is typically, but not limited to, 1 μm to 20 μm, which may be appropriately selected as needed.

Active Material

The electrode active material in the electrode of the present invention for use in a lithium-ion secondary battery may be any material capable of storing and releasing lithium ions, which may be any known electrode active material for lithium-ion secondary batteries.

When the electrode of the present invention for use in a lithium-ion secondary battery is a positive electrode, the positive electrode active material layer may include, for example, LiCoO₂, LiCoO₄, LiMn₂O₄, LiNiO₂, LiFePO₄, lithium sulfide, or sulfur. The positive electrode active material may be selected from materials that are available to form an electrode and have a potential more noble than that for the negative electrode.

When the electrode of the present invention for use in a lithium-ion secondary battery is a negative electrode, examples of the negative electrode active material include metallic lithium, lithium alloys, metal oxides, metal sulfides, metal nitrides, silicon oxide, silicon, and carbon materials, such as graphite. The negative electrode active material may be selected from materials that are available to form an electrode and have a potential less noble than that for the positive electrode.

Position of Electrode Layer

In the first mode of the electrode of the present invention for use in a lithium-ion secondary battery, the electrode layer including an electrode material mixture including, as essential components, an electrode active material and the electrolytic solution-absorbing particles of the present invention should be provided on at least one side of the current collector and may be provided on each side of the current collector. The position of the electrode layer may be appropriately selected depending on the type or structure of the desired lithium-ion secondary battery.

Thickness

For example, the thickness of the first mode of the electrode of the present invention for use in a lithium-ion secondary battery is preferably, but not limited to, 40 μm or more. The electrode with a thickness of 40 μm or more and filled with an electrode active material at a volume percentage of 60% or more can have a high-density for a lithium-ion secondary battery. Such an electrode can form a battery cell with a volume energy density as high as 500 Wh/L or more.

Method for Producing Electrode for Use in Lithium-Ion Secondary Battery

The first mode of the electrode of the present invention including an electrode active material and the electrolytic solution-absorbing particles of the present invention may be produced by any appropriate method. The first mode of the electrode may be produced using a method conventional in the art.

For example, such a method includes applying, onto a current collector, an electrode material paste for forming an electrode material mixture, which includes, as essential components, an electrode active material and the electrolytic solution-absorbing particles of the present invention; drying the paste; and then subjecting the dried paste to rolling.

A known method may be used to apply the electrode material paste to the current collector. Examples of such a method include roll coating, such as applicator roll coating, screen coating, blade coating, spin coating, and bar coating.

Second Mode (Multilayer Type)

A second mode of the electrode of the present invention for use in a lithium-ion secondary battery includes a current collector; an electrode active material layer provided on at least one side of the current collector and including an electrode active material; and an electrolytic solution-absorbing layer provided on the electrode active material layer and including the electrolytic solution-absorbing particles of the present invention.

In a lithium-ion secondary battery, the electrolytic solution-absorbing layer on the electrode active material layer in the second mode of the electrode of the present invention is preferably in contact with the separator.

In a lithium-ion secondary battery, the electrolytic solution-absorbing layer including the electrolytic solution-absorbing particles of the present invention provided at the interface between the separator and the electrode active material layer of the second mode of the electrode can increase the toughness of the cell against internal short-circuiting.

Moreover, the electrolytic solution-absorbing particles of the present invention have the function of retaining a sufficient amount of the electrolytic solution to prevent the electrolytic solution from being pushed out due to expansion and contraction of the electrode during charge and discharge and to prevent shortage of the electrolytic solution. As a result, lithium ions can smoothly move between the electrode active material layer and the separator, which further improves charge and discharge characteristics and cycle life time.

The second mode of the electrode of the present invention for use in a lithium-ion secondary battery may be a positive electrode or a negative electrode. Therefore, the electrode active material in the electrode active material layer of the electrode for use in a lithium-ion secondary battery may be a positive electrode active material or a negative electrode active material. The present invention is advantageously effective for both the positive and negative electrodes.

Active Material

The positive and negative electrode active materials used in the second mode of the electrode for use in a lithium-ion secondary battery may be the same as those used in the first mode of the electrode for use in a lithium-ion secondary battery.

Position of Electrolytic Solution-Absorbing Layer

In the second mode of the electrode for use in a lithium-ion secondary battery, the electrolytic solution-absorbing layer including the electrolytic solution-absorbing particles of the present invention is provided or the electrode active material layer. In a lithium-ion secondary battery, the electrolytic solution-absorbing layer should be provided in contact with the surface of the separator when the electrode active material layer is provided on each side of the current collector.

Thickness

In the second mode of the electrode of the present invention for use in a lithium-ion secondary battery, the electrolytic solution-absorbing layer including the electrolytic solution-absorbing particles of the present invention may have any thickness, for example, which is preferably in the range of 1/100 of the average particle size (D50) of the dielectric oxide solid to the overage particle size (D50).

The second mode of the electrode of the present invention for use in a lithium-ion secondary battery may also have any thickness. Like the first mode of the electrode of the present invention for use in a lithium-ion secondary battery, the second mode of the electrode may have a thickness of 40 μm or more and may be filled with an electrode active material at a volume percentage of 60% or more, so that it can have a high density for a lithium-ion secondary battery.

Method for Producing Electrode for Use in Lithium-Ion Secondary Battery

The second mode of the electrode of the present invention including an electrode active material layer and an electrolytic solution-absorbing layer provided on the electrode active material layer and including the electrolytic solution-absorbing particles of the present invention may be produced by any appropriate method. The second mode of the electrode may be produced using a method conventional in the art.

For example, such a method may be similar to that for producing the first mode of the electrode and may include applying, onto a current collector, an electrode material paste that contains an electrode active material and is for forming an electrode material mixture; drying the paste; then subjecting the dried paste to rolling to form an electrode active material layer; and then overcoating the active material layer with a particle dispersion paste containing the electrolytic solution-absorbing particles of the present invention.

A known method may be used to overcoat the active material layer with a particle dispersion paste containing the electrolytic solution-absorbing particles. Examples of such a method include roll coating, such as applicator roll coating, screen coating, blade coating, spin coating, and bar coating.

Separator

The separator of the present, invention is a separator that is for use in a lithium-ion secondary battery and includes a base material, and an electrolytic solution-absorbing layer provided on at least one side of the base material and including the electrolytic solution-absorbing particles of the present invention. The separator may have any size, any thickness, and any other dimensions.

In a lithium-ion secondary battery, the separator of the present invention is provided between the positive and negative electrode layers.

The base material of the separator may be any known material for a lithium-ion secondary battery separator.

Method for Producing Separator

The separator of the present invention may be produced by any appropriate method. For example, such a method includes overcoating the base material with a particle dispersion paste containing the electrolytic solution-absorbing particles of the present invention and optional components.

A known method may be used to overcoat the base material with a particle dispersion paste containing the electrolytic solution-absorbing particles. Examples of such a method include roll coating, such as applicator roll coating, screen coating, blade coating, spin coating, and bar coating.

Lithium-Ion Secondary Battery

The lithium-ion secondary battery of the present invention includes a positive electrode layer including a positive electrode active material layer including a positive electrode active material; a negative electrode layer including a negative electrode active material layer including a negative electrode active material; a separator provided between the positive electrode layer and the negative electrode layer; and an electrolytic solution. The lithium-ion secondary battery of the present invention is characterized by including an electrolytic solution-absorbing layer provided between the separator and the positive electrode layer and/or the negative electrode layer and including the electrolytic solution-absorbing particles of the prevent invention.

Positive Electrode Layer of Lithium-Ion Secondary Battery

The positive electrode layer as a component of the lithium-ion secondary battery of the present invention includes a positive electrode material layer including a positive electrode active material. The positive electrode layer may include any other components as long as it includes a positive electrode active material layer and may be any known positive electrode layer used for lithium-ion secondary batteries.

In the present invention, the positive electrode is preferably the first or second mode of the electrode described above. Specifically, the positive electrode layer preferably includes a positive electrode material mixture including a positive electrode active material and the electrolytic solution-absorbing particles of the present invention and is preferably provided on the current collector in the lithium-ion secondary battery, or the positive electrode layer preferably includes an electrode active material layer, which is provided on the current collector; and an electrolytic solution-absorbing layer provided on the electrode active material layer and including the electrolytic solution-absorbing particles of the present invention.

Negative Electrode Layer of Lithium-Ion Secondary Battery

The negative electrode layer as a component of the lithium-ion secondary battery of the present invention includes a negative electrode material layer including a negative electrode active material. The negative electrode layer may include any other components as long as it includes a negative electrode active material layer and may be any known negative electrode layer used for lithium-ion secondary batteries.

In the present invention, the negative electrode is preferably the first or second mode of the electrode described above. Specifically, the negative electrode layer preferably includes a negative electrode material mixture including a negative electrode active material and the electrolytic solution-absorbing particles of the present invention and is preferably provided on a current collector in the lithium-ion secondary battery, or the negative electrode layer preferably includes an electrode active material layer, which is provided on the current collector; and an electrolytic solution-absorbing layer provided on the electrode active material layer and including the electrolytic solution-absorbing particles of the present invention.

Separator

The separator as a component of the lithium-ion secondary battery of the present invention may be any type and may be any known separator used for lithium-ion secondary batteries.

In the present Invention, the separator is preferably one according to the present invention described above. Specifically, the separator preferably includes a base material and an electrolytic solution-absorbing layer provided on at least one side of the base material and including the electrolytic solution-absorbing particles of the present invention.

Electrolytic Solution

In the lithium-ion secondary battery of the present invention, the electrolytic solution may be any type and may be any known electrolytic solution used for lithium-ion secondary batteries.

Solvent

The solvent in the electrolytic solution may be a common solvent used to form nonaqueous electrolytic solutions. Examples of such a solvent include cyclic structure-containing solvents such as ethylene carbonate (EC) and propylene carbonate (PC) and chain structure-containing solvents such as dimethyl carbonate (DMC), ethyl methyl carbonate (EMC) and diethyl carbonate (DEC). Partially fluorinated solvents may also be used such as fluoroethylene carbonate (FEC) and difluoroethylene carbonate (DFEC).

The electrolytic solution may also contain a known additive such as vinylene carbonate (VC) vinyl ethylene carbonate (VEC), or propanesultone (PS).

The electrolytic solution may also contain an ionic liquid. Examples of the ionic liquid include pyrrolidinium, piperidinium and imidazolium, which form quaternary ammonium cations.

In the present invention, a solvent with high relative permittivity such as EC or PC is preferably used in combination with a solvent with low viscosity such as DMC or EMC. The use of a solvent with high relative permittivity allows a lithium salt to have a high degree of dissociation and to be used at a high concentration. The use of only a solvent with high relative permittivity may cause an increase in viscosity and a reduction in ionic conductivity. Therefore a low-viscosity solvent and a solvent with high relative permittivity should be mixed in a suitable ratio for adjustment of the viscosity. The content of the solvent with thigh relative permittivity, such as DC or PC, in the electrolytic solution is preferably 20% by volume or more and 40% by volume or less. The content of the solvent with high relative permittivity is more preferably 25% by volume or more and 35% by volume or less.

Lithium Salt

In the lithium-ion secondary battery of the present invention, the electrolytic solution may contain any type of lithium salt. Examples of the lithium salt include LiPF₆, LiBF₄, LiClO₄, LiN (SO₂CF₃), LiN(SO₂C₂F₅)₂, and LiCF₃SO₃. Among them, LiPF₆, LiBF₄, or a mixture thereof is preferred because of their high ionic conductivity and high degree of dissociation.

Method for Producing Lithium-Ion Secondary Battery

The lithium-ion secondary battery of the present invention may be produced using any method conventional in the art.

### EXAMPLES

Hereinafter, the present invention will be described in more detail with reference to examples, which are not intended to limit the present, invention. The materials shown below were used in the examples and the comparative examples.

(1) Electrode Active Material

Positive electrode active material: LiNi_{0.6}Co_{0.2}Mn_{0.2}O₂ (NCM622) (D50: 12 μm)
Negative electrode active material: natural graphite (NG) (D50: 12 μm)

(2) Lithium-Ion Conductive Oxide

Li_{1.3}Al_{0.3}Ti_{1.7}P₃O₁₂ (LATP) (D50: 0.5 μm, lithium-ionic conductivity in bulk form: 5×10⁻⁴ S/cm, relative permittivity in powder form: 30)
Li₇La₃Zr₂O₁₂ (LLZO) (D50: 0.15 μm, lithium-ionic conductivity in bulk form: 5×10⁻⁴ S/cm, relative permittivity in powder form: 48.7)

(3) Ferroelectric Oxide

BaTiO₃ (BTO) (050: 0.6 μm, relative permittivity in powder form: 67)

(4) Oxide

Al₂O₃ (D50: 0.3 μm, relative permittivity in powder form: 8.7)

(5) Material for. Forming Resin Layer

Poly(vinylidene fluoride-co-hexafluoropropylene) (PVDF-HFP) Polyvinyl chloride (PVC)

Preparation of Electrolytic Solution-Absorbing Particles

Electrolytic Solution-Absorbing Particles Nos. 1 to 4 PVDF-HFP was used to form a resin layer. PVDF-HFP was dissolved in acetone. Ethylene carbonate (EC) as a plasticizer and LATP (relative permittivity in powder form: 30) as a lithium-ion conductive oxide were then mixed and dispersed in the solution to form a dispersion. Subsequently, the dispersion was continued to be stirred with a stirrer until the acetone as the dispersion medium was evaporated, so that a powder was obtained. Electrolytic solution-absorbing particles were obtained by immersing the resulting powder in dimethyl carbonate (DMC) so that the EC as a plasticizer was removed and pores were formed in the resin layer.

Table 1 shows the composition of each of the resulting electrolytic solution-absorbing particles Nos. 1 to 4 and the porosity of each resin layer.

Electrolytic Solution-Absorbing Particles No. 5 Polyvinyl chloride (PVC) was used to form a resin layer. PVC was dissolved in tetrahydrofuran (THF). EC as a plasticizer and LLZO (relative permittivity in powder form: 48.7) as a lithium-ion conductive oxide were then mixed and dispersed in the solution to form a dispersion. Subsequently, the dispersion was continued to be stirred with a stirrer until the THF as the dispersion medium was evaporated, so that a powder was obtained. Electrolytic solution-absorbing particles were obtained by immersing the resulting powder in DMC so that the EC as a plasticizer was removed and pores were formed in the resin layer.

Table 1 shows the composition of the resulting electrolytic solution-absorbing particles No. 5 and the porosity of the resin layer.

Electrolytic Solution-Absorbing Particles No. 6 PVDF-HFP was used to form a resin layer. PVDF-HFP was dissolved in acetone. EC as a plasticizer and BTO (relative permittivity in powder form: 67; as a dielectric oxide were then mixed and dispersed in the solution to form a dispersion. Subsequently, the dispersion was continued to be stirred with a stirrer until the acetone as the dispersion medium was evaporated, so that a powder was obtained. Electrolytic solution-absorbing particles were obtained by immersing the resulting powder in DMC so that the EC as a plasticizer was removed and pores were formed in the resin layer.

Table 1 shows the composition of the resulting electrolytic solution-absorbing particles No. 6 and the porosity of the resin layer.

Electrolytic Solution-Absorbing Particles No. 7 PVDF-HFP was used to form a resin layer. PVDF-HFP was dissolved in acetone. EC as a plasticizer and Al₂O₃ (relative permittivity in powder form: 8.7) as an oxide were then mixed and dispersed in the solution to form a dispersion. Subsequently, the dispersion was continued to be stirred with a stirrer until the acetone as the dispersion medium was evaporated, so that a powder was obtained. Electrolytic solution-absorbing particles were obtained by immersing the resulting powder in DMC so that the EC as a plasticizer was removed and pores were formed in the resin layer.

Table 1 shows the composition of the resulting electrolytic solution-absorbing particles No. 7 and the porosity of the resin layer.

TABLE 1

| | Electrolytic | Electrolytic | Electrolytic | Electrolytic | Electrolytic | Electrolytic | Electrolytic |
|---|---|---|---|---|---|---|---|
| | solution- | solution- | solution- | solution- | solution- | solution- | solution- |
| | absorbing | absorbing | absorbing | absorbing | absorbing | absorbing | absorbing |
| | particles | particles | particles | particles | particles | particles | particles |
| | No. 1 | No. 2 | No. 3 | No. 4 | No. 5 | No. 6 | No. 7 |
| Particles | LATP | LATP | LATP | LATP | LLZ | BTO | Al₂O₃ |
| Resin | PVDF-HFP | PVDF-HFP | PVDF-HFP | PVDF-HFP | PVC | PVDF-HFP | PVDF-HFP |
| Plasticizer | EC | EC | EC | EC | EC | EC | EC |
| Mass ratio | 56/17/27 | 32/25/43 | 56/33/11 | 56/38/6 | 56/14/30 | 56/14/30 | 56/14/30 |
| (particles/resin/plasticizer) | | | | | | | |
| Porosity of resin layer (%) | 68 | 68 | 31 | 18 | 65 | 68 | 68 |

### Examples 1 to 7 and Comparative Examples 1 and 2

Preparation of Positive Electrode

The electrolytic solution-absorbing particles, acetylene black (AB) as a conductive aid, PVDF as a binder, and N-methyl-N-pyrrolidinone (NMP) as a medium were wet-mixed in the composition shown in Tables 2 and 3 using a planetary centrifugal mixer to give a premix slurry. Subsequently, NCM622 as a positive electrode active material and the premix slurry were mixed in the composition shown in Tables 2 and 3, and the mixture was subjected to a dispersion process using a planetary mixer to give a positive electrode material paste. The step of adding the electrolytic solution-absorbing particles was omitted when the positive electrode material paste was prepared without the electrolytic solution-absorbing particles.

The resulting positive electrode material paste was applied to one side of a 12 μm-thick, Al current collector, dried at 120° C. for 10 minutes, and then pressed at a linear pressure of 1 t/cm using a roll press. The product was then dried in vacuo at 120° C. to form a positive electrode for a lithium-ion secondary battery. The resulting positive electrode was punched into a sire of 30 mm×40 mm before use.

Preparation of Negative Electrode

The electrolytic solution-absorbing particles, acetylene black (AB) as a conductive aid, an aqueous solution of carboxymethyl cellulose (CMC) as a binder were mixed in the composition shown in Tables 2 and 3 and dispersed using a planetary mixer to form a mixture. The resulting mixture was mixed with natural graphite (NG) as a negative electrode active material and dispersed again using a planetary mixer. Subsequently, water as a dispersion medium and styrene butadiene rubber (SBR) as a binder were added in the composition shown in Table 2 to the mixture and dispersed to form a negative electrode material paste. The step of adding the electrolytic solution-absorbing particles was omitted when the negative electrode material paste was prepared without the electrolytic solution-absorbing particles.

The resulting negative electrode material paste was applied to an 8 μm-thick, Cu current collector, dried at 100° C. for 10 minutes, and then pressed at a linear pressure of 1 t/cm using a roll press. The product was then dried in vacuo at 100° C. to form a negative electrode for a lithium-ion secondary battery. The resulting negative electrode was punched into a size of 34 mm×44 mm before use.

TABLE 2

| | | Example 1 | Example 2 | Example 3 | Example 4 | Example 5 | Example 6 | Example 7 |
|---|---|---|---|---|---|---|---|---|
| Position of electrolytic solution-absorbing | | Positive | Positive | Positive | Positive | Negative | Positive | Positive |
| particles | | electrode | electrode | electrode | electrode | electrode | electrode | electrode |
| Type of particles for positive electrode | | No. 1 | No. 2 | No. 3 | No. 4 | — | No. 6 | No. 7 |
| Composition of | Electrolytic solution- | 1.0 | 1.0 | 1.0 | 5.0 | 0.0 | 1.0 | 0.1 |
| positive electrode | absorbing particles | | | | | | | |
| (wt %) | Positive electrode active | 93.0 | 93.0 | 93.0 | 89.0 | 94.0 | 93.0 | 93.9 |
| | material | | | | | | | |
| | Acetylene black | 4.1 | 4.1 | 4.1 | 4.1 | 4.1 | 4.1 | 4.1 |
| | PVDF | 1.9 | 1.9 | 1.9 | 1.9 | 1.9 | 1.9 | 1.9 |
| Type of particles for negative electrode | | — | — | — | — | No. 5 | — | — |
| Composition of | Electrolytic solution- | 0.0 | 0.0 | 0.0 | 0.0 | 0.5 | 0.0 | 0.0 |
| negative electrode | absorbing particles | | | | | | | |
| (wt %) | Negative electrode active | 96.5 | 96.5 | 96.5 | 96.5 | 96.0 | 96.0 | 96.5 |
| | material | | | | | | | |
| | Acetylene black | 1.0 | 1.0 | 1.0 | 1.0 | 1.0 | 1.0 | 1.0 |
| | CMC | 1.0 | 1.0 | 1.0 | 1.0 | 1.0 | 1.0 | 1.0 |
| | SBR | 1.5 | 1.5 | 1.5 | 1.5 | 1.5 | 1.5 | 1.5 |
| Initial performance | Discharge capacity [mAh] | 41.8 | 41.8 | 41.8 | 43.0 | 42.1 | 43.3 | 41.8 |
| | SOC 50 resistance [Ω] | 0.985 | 0.985 | 0.985 | 0.985 | 0.985 | 0.985 | 0.985 |
| Performance after | Discharge capacity [mAh] | 34.7 | 34.8 | 34.7 | 35.2 | 35.1 | 36.0 | 34.3 |
| endurance test | SOC 50 resistance [Ω] | 1.482 | 1.478 | 1.482 | 1.507 | 1.478 | 1.482 | 1.502 |

| | | | | | | | |
|---|---|---|---|---|---|---|---|
| Capacity retention after endurance test (%) | 83.1 | 83.3 | 83.1 | 81.8 | 83.3 | 83.1 | 82.1 |
| Rate of increase in resistance after endurance | 150.5 | 150.0 | 150.5 | 153.0 | 150.0 | 150.5 | 152.5 |
| test (%) | | | | | | | |

TABLE 3

| | | Comparative | Comparative |
|---|---|---|---|
| | | Example 1 | Example 2 |
| Position of electrolytic solution-absorbing | | — | Positive |
| particles | | | electrode |
| Type of particles for positive electrode | | — | No. 7 |
| Composition of | Electrolytic solution- | 0.0 | 0.5 |
| positive electrode | absorbing particles | | |
| (wt %) | Positive electrode | 94.0 | 93.5 |
| | active material | | |
| | Acetylene black | 4.1 | 4.1 |
| | PVDF | 1.9 | 1.9 |
| Type of particles for negative electrode | | — | — |
| Composition of | Electrolytic solution- | 0.0 | 0.0 |
| negative electrode | absorbing particles | | |
| (wt %) | Negative electrode | 96.5 | 96.5 |
| | active material | | |
| | Acetylene black | 1.0 | 1.0 |
| | CMC | 1.0 | 1.0 |
| | SBR | 1.5 | 1.5 |
| Initial | Cell capacity [mAh] | 42.5 | 42.0 |
| | Internal cell resistance | 1.0 | 1.2 |
| | [Ω] | | |
| After endurance test | Cell capacity [mAh] | 34.3 | 33.6 |
| | Internal cell resistance | 1.67 | 1.88 |
| | [Ω] | | |

| | | |
|---|---|---|
| Capacity retention after endurance test (%) | 80.8 | 80.0 |
| Rate of increase in resistance after | 167.0 | 155.0 |
| endurance test (%) | | |

### Examples 8 to 11 and Comparative Example 3

Preparation of Positive Electrode

Acetylene black (AB) as a conductive aid, PVDF as a binder, and N-methyl-N-pyrrolidinone (NMP) as a medium were wet-mixed using a planetary centrifugal mixer to give a premix slurry. Subsequently, NCM622 as a positive electrode active material and the resulting premix slurry were mixed and subjected to a dispersion process using a planetary mixer to give a positive electrode material paste.

The positive electrode material paste in each of Examples 8 to 11 and Comparative Example 3 had a mass composition ratio of HCM622, AB, and PVDF of 94.0:4.1:1.9.

The resulting positive electrode material paste was applied to one side of a 12 μm-thick, Al current, collector, dried at 120° C. for 10 minutes, and then pressed at a linear pressure of 1 t/cm using a roll press. The product was then dried in vacuo at 120° C. to form a positive electrode for a lithium-ion secondary battery. The resulting positive electrode was punched into a size of 30 mm×40 mm before use.

Preparation of Negative Electrode

Acetylene black (AB) as a conductive aid and an aqueous solution of carboxymethyl cellulose (CMC) as a binder were premixed using a planetary mixer. Subsequently, the resulting mixture was mixed with natural graphite (NG) as a negative electrode active material and premixed again using a planetary mixer. Subsequently, water as a dispersion medium and styrene butadiene rubber (SBR) as a binder were added to the mixture and subjected to a dispersion process using a planetary mixer to form a negative electrode material paste.

The negative electrode material paste in each of. Examples 8 to 11 and Comparative Example 3 had a mass composition ratio of NG, AB, SBR, and CMC of 96.5:1.0:1.5:1.0.

Preparation of Electrolytic Solution-Absorbing Layer

The electrolytic solution-absorbing particles shown in Table 4 and CMC were mixed in a mass ratio of 95:5 with water as a dispersion medium to form a dispersion paste. The surface of the electrode active material layer of the positive or negative electrode formed as shown above was overcoated with the resulting dispersion paste as shown in Table 4. The paste was then dried at 100° C. to form an electrolytic solution-absorbing layer with a thickness as shown in Table 4.

Preparation of Lithium-Ion Secondary Battery

A lithium-ion secondary battery was prepared as in Example 1 except that a combination of the positive or negative electrode having the resulting electrolytic solution-absorbing layer and the negative or positive electrode having no electrolytic solution-absorbing layer was used as shown in Table 4.

TABLE 4

| | | | | | | Comparative |
|---|---|---|---|---|---|---|
| | | Example 8 | Example 9 | Example 10 | Example 11 | Example 3 |
| Position of electrolytic solution-absorbing | | Positive | Positive | Positive | Negative | Negative |
| particles | | electrode | electrode | electrode | electrode | electrode |
| | | interface | interface | interface | interface | interface |
| Type of particles for positive electrode | | No. 1 | No. 1 | No. 1 | — | — |
| Composition of layer | Electrolytic solution- | 95.0 | 95.0 | 95.0 | — | — |
| (wt %) | absorbing particles | | | | | |
| | CMC | 5.0 | 5.0 | 5.0 | — | — |
| Thickness of electrolytic solution-absorbing | | 2 | 5 | 1 | — | — |
| layer (μm) | | | | | | |
| Type of particles for negative electrode | | — | — | — | No. 5 | No . 7 |
| Composition of layer | Electrolytic solution- | — | — | — | 95.0 | 95.0 |
| (wr %) | absorbing particles | | | | | |
| | CMC | — | — | — | 5.0 | 5.0 |
| Thickness of electrolytic solution-absorbing | | — | — | — | 3 | 5 |
| layer (μm) | | | | | | |
| Initial | Cell capacity[mAh] | 42.5 | 42.5 | 42.5 | 42.5 | 42.5 |
| | Internal cell resistance | 0.99 | 0.99 | 0.99 | 0.98 | 0.98 |
| | [Ω] | | | | | |
| After endurance test | Cell capacity[mAh] | 35.0 | 35.1 | 35.0 | 35.1 | 34.4 |
| | Internal cell resistance | 1.50 | 1.50 | 1.50 | 1.48 | 1.51 |
| | [Ω] | | | | | |

| | | | | | |
|---|---|---|---|---|---|
| Capacity retention after endurance test (%) | 82.5 | 82.6 | 82.3 | 82.6 | 81.1 |
| Rate of increase in resistance after | 151.7 | 151.5 | 152.0 | 151.5 | 154.5 |
| endurance test (%) | | | | | |

Evaluation

The lithium-ion secondary battery obtained in each of the examples and the comparative examples was evaluated as shown below.

Initial Discharge Capacity

The resulting lithium-ion secondary battery was allowed to stand at a measurement temperature (25° C.) for 1 hour, then charged at a constant current of 8.4 mA until 4.2 V was reached, subsequently charged at a constant voltage of 4.2 V for 1 hour, then allowed to stand for 30 minutes, and then discharged at a constant current of 8.4 mA until 2.5 v was reached. The process was repeated 5 times, in which the initial discharge capacity was defined as the discharge capacity at the fifth discharge. Tables 2 to 4 show the results. The current value at which the discharge was completed in 1 hour was normalized to 1 C with respect to the resulting discharge capacity.

Initial Cell Resistance

After the measurement of the initial discharge capacity, the lithium-ion secondary battery was allowed to stand at a measurement temperature (25° C.) or 1 hour and then charged at 0.2 C such that the charge level (state of charge (SOC)) reached 50%, and then allowed to stand for 10 minutes. Subsequently, the lithium-ion secondary battery was pulse-discharged at a C rate of 0.5 C for 10 seconds, during which the voltage was measured. The current value was plotted on the horizontal axis, and the 10 second-discharge voltage for the current at 0.5 C was plotted on the vertical axis. Next, after being allowed to stand for 10 minutes, the lithium-ion secondary battery was supplementarily charged until SOC returned to 50%, and then further allowed to stand for 10 minutes.

The operation shown above was performed at each of the C rates 1.0 C, 1.5 C, 2.0 C, 2.5 C, and 3.0 C, and the 10 second-discharge voltage was plotted against the current value at each C rate. The internal resistance of the lithium-ion secondary battery was defined as the slope of an approximate straight line obtained from the plots by least squares method. Tables 2 to 4 show the results.

Discharge Capacity after Endurance Test

In a thermostatic chamber at 45° C., the lithium-ion secondary battery was subjected to a charge and discharge cycle endurance test including 1,000 cycles of constant-current charging to 4.2 V at a charge rate of 1 C and then constant-current discharging to 2.5 V at a discharge rate of 2 C. After the completion of the 1,000 cycles, the lithium-ion secondary battery was allowed to stand for 24 hours in the thermostatic chamber with the temperature changed to 25° C., then charged at a constant current of 0.2 C until 4.2 V was reached, subsequently charged at a constant voltage of 4.2 V for 1 hour, then allowed to stand for 30 minutes, and then discharged at a discharge rate of 0.2 C until 2.5 V was reached. Subsequently, the discharge capacity after the endurance test was measured. Tables 2 to 4 show the results.

Cell Resistance after Endurance Test

After the measurement of the discharge capacity after the endurance test, the lithium-ion secondary battery was charged until 50C (state of charge) reached 50% as in the measurement of the initial cell resistance. Subsequently, the cell resistance after the endurance test was determined using the same method as for the measurement of the initial cell resistance. Tables 2 and 4 show the results.

Capacity Retention

The capacity retention was determined as the percentage ratio of the measured discharge capacity after the endurance test to the measured initial discharge capacity. Tables 2 to 4 show the results.

Rate of Increase in Cell Resistance

The rate of increase in cell resistance was determined as the percentage ratio of the measured cell resistance after the endurance test to the measured initial cell resistance. Tables 2 to 4 show the results.

1. Electrolytic solution-absorbing particles each comprising: a high-dielectric oxide solid;
and a resin layer that is provided on a surface of the high-dielectric oxide solid and is capable of absorbing an electrolytic solution,
the resin layer having pores in which an electrolytic solution is to be filled and absorbed,
the pores having a volume content of 30 vol % or more based on a volume of the resin layer.

2. The electrolytic solution-absorbing particles according to claim 1, wherein the high-dielectric oxide solid is an oxide having lithium ion conductivity.

3. The electrolytic solution-absorbing particles according to claim 1, wherein the high-dielectric oxide solid is a ferroelectric oxide having a relative permittivity of 10 or more when in a powder form.

4. The electrolytic solution-absorbing particles according to claim 1, wherein the high-dielectric oxide solid has a lithium-ionic conductivity of 10⁻⁷ S/cm or more at 25° C.

5. The electrolytic solution-absorbing particles according to claim 1, wherein the high-dielectric oxide solid is a complex metal oxide having a garnet structure represented by the formula: Li_{7-y}La₃₋ₓAₓZr_{2-y}M_{y}O₁₂, wherein A is any one metal selected from the group consisting of Y, Nd, Sm, and Gd, x is in a range of 0 to less than 3 (0≤x<3), M is Nb or Ta, and is in a range of 0 to less than 2 (0≤y<2).

6. The electrolytic solution-absorbing particles according to claim 1, wherein the high-dielectric oxide solid is a complex metal oxide comprising a crystal represented by the formula: Li_{1+x+y}(Al,Ga)ₓ(Ti,Ge)₂₋ₓSi_{y}P_{3-y}O₁₂, wherein 0≤x≤1 and 0≤y≤1.

7. (canceled)

8. (canceled)

9. A self-supporting sheet comprising the electrolytic solution-absorbing particles according to claim 1.

10. An electrode for use ftp a lithium-ion secondary battery, the electrode comprising: an electrode active material; and the electrolytic solution-absorbing particles according to claim 1.

11. The electrode according to claim 10 for use in a lithium-ion secondary battery, containing 0.1 parts by mass or more and 5 parts by mass or less of the electrolytic solution-absorbing particles based on 100 parts by mass of the electrode.

12. The electrode according to claim 10 for use in a lithium-ion secondary battery, wherein the electrode active material is a positive electrode active material.

13. The electrode according to claim 10 for use in a lithium-ion secondary battery, wherein the electrode active material is a negative electrode active material.

14. An electrode for use in a lithium-ion secondary battery, the electrode comprising:
a current collector;
an electrode active material layer that is provided on at least one side of the current collector and comprises an electrode active material; and
an electrolytic solution-absorbing layer that is provided on the electrode active material layer and comprises the electrolytic solution-absorbing particles according to claim 1.

15. The electrode according to claim 14 for use in a lithium-ion secondary battery, wherein the electrolytic solution-absorbing layer is provided to come into contact with a separator when used to form a lithium-ion secondary battery.

16. The electrode according to claim 14 for use in a lithium-ion secondary battery, wherein the electrode active material is a positive electrode active material.

17. The electrode according to claim 14 for use in a lithium-ion secondary battery, wherein the electrode active material is a negative electrode active material.

18. A separator for use a lithium-ion secondary battery, the separator comprising: a base material; and an electrolytic solution-absorbing layer that is provided on at least one side of the base material and comprises the electrolytic solution-absorbing particles according to claim 1.

19. A lithium-ion secondary battery comprising:
a positive electrode layer comprising a positive electrode active material layer comprising a positive electrode active material;
a negative electrode layer comprising a negative electrode active material layer comprising a negative electrode active material;
a separator provided between the positive electrode layer and the negative electrode layer;
an electrolytic solution; and
an electrolytic solution-absorbing layer that is provided between the separator and the positive electrode layer and/or the negative electrode layer and comprises the electrolytic solution-absorbing particles according to claim 1.
